(19) United States
(12) Patent Application Publication
(10) Pub. No.: US 2015/0244771 A1
(43) Pub. Date: Aug. 27, 2015

(54) System and method for interconnecting and enforcing policy between multiple disparate providers of application functionality and data centers and/or end-users

(71) Applicant: Bat Blue Networks, Clifton, NJ (US)

(72) Inventors: Babak Pasdar, Clifton, NJ (US); Wes Johnston, Clifton, NJ (US)

(73) Assignee: Bat Blue Networks, Clifton, NJ (US)

(21) Appl. No.: 14/186,748

(22) Filed: Feb. 21, 2014

(51) Int. Cl. H04L 29/08; H04L 12/24

(52) U.S. Cl. CPC H04L 67/10; H04L 41/50

(57) ABSTRACT

A system and method for interconnecting and enforcing policy between multiple disparate providers of application functionality, data centers or end-users. A network system comprising one or more Perimeter Points of Presence (P/PoP) configured to interconnect and enforce policy between a plurality of entities, each of which provides at least one function, the one or more Perimeter Points of Presence (P/PoP) comprising: a network interface component configured to accept physical or virtual connections or both; a plurality of functions layers for processing data, wherein the function layers can be configured to provide a customized virtual perimeter for the entities. The one or more Perimeter Points of Presence (P/PoP) are configured to receive data via a connection to the Perimeter Points of Presence (P/PoP); process the data using at least one of the function layers configured as a data processing policy for the entity; and transmit the processed data as policy compliant data from the one or more Perimeter Points of Presence (P/PoP) to a destination connected to the Perimeter Points of Presence (P/PoP).

### FIELD

This invention primarily relates to the field of computer networking, security and application delivery. In particular, this invention provides the means to virtually interconnect multiple disparate application provider services and functionality to deliver one or more contiguous applications services.

### DESCRIPTION OF RELATED ART

Organizations leverage their applications internally in support of their operations, externally for customers and/or partners or both. In doing so they may utilize a data center they own and operate, a co-located data center, a cloud service, an application in the cloud provider, or even a mobile device to support their applications. Furthermore, many applications today consist of several tiers of architecture. An example is an application that may have a front-end web system, a middle-ware system, an authentication system, and a backend database system.

Historically, the various tiers of an application have been delivered, within a single data center, be it an organization owned and operated data center, a co-located data center, or cloud instance. With a cloud instances, it should be noted that even though the term “cloud” is used, they deliver services very similar to or as a single data center, with the major differentiation being different ownership and or management.

### SUMMARY

A new breed of service providers are arising that offer specific granular functions, which when combined with other functions from one or more other service providers along with their associated configurations can collectively form one or more applications. In other words, an application is a collection of one or more functions, from one or more service providers, that can be combined with custom configurations of the function which comprises the application.

For example a service may exclusively offer web hosting functionality, another may offer middleware (programmatic functions), yet another database functionality, and another authentication services. Quite often the limitation is that these providers interact over the Internet. They have limited if any means to facilitate purpose-built communications, standardized data flow and security functions and policies along with the visibility, controls or anonymity.

Described herein are embodiments of systems and methods that facilitate the practical interconnection and provision of a well-developed and standardized data flow along with a host of functionalities such as security, application delivery, application resiliency and acceleration between multiple providers of functions. A user may leverage these systems and methods as a binding and control component between the multiple providers of functions that make up one or more applications.

For example an organization may utilize the services of multiple providers of functionality, one of which may deliver front-end web and content services only, another may offer middle-ware services, yet another authentication, and another backend database services, the collection of which along with their specific configurations would comprise the user application. The user may do this in order to deliver a complete application without the acquiring data center space, use of cloud instances, servers, operating systems, and or purchased and or licensed software or for the purposes of leveraging the specialties of these organizations, or both.

Alternatively the user may utilize a combination of providers of functionalities and other more standard resources such as data center driven software while utilizing this invention as the means of interconnecting, enforcing data flow and controls.

This process of interconnecting multiple providers of functionality can be referred to as a “Virtual Data Center.”

Embodiments of the systems and methods described herein provide an interconnection between multiple geographically distributed providers of functionality(s) and or software platforms; utilizing a variety of connectivity methods including public, hybrid, and or private networks that leverage physical, virtual, and or controlled connectivity methods, while providing enforcement of data flow and controls including visibility, assessment, and or enforcement of granular organizational policy between the various providers of functionality(s) and or end-users and or end-user devices.

The present application discloses a network system and methods therefor comprising one or more Perimeter Points of Presence (P/PoP) configured to interconnect and enforce policy between a plurality of entities, each of which provides a function, the one or more P/PoP comprising: a network interface component configured to accept physical or virtual connections or both; a plurality of functions layers for processing data, wherein the function layers can be configured to provide a customized virtual perimeter for the entities. The one or more P/PoP are configured to receive data via a connection to the P/PoP; process the data using at least one of the function layers configured as a data processing policy for the entity; and transmit the processed data as policy compliant data from the one or more P/PoP to a destination connected to the P/PoP. Exemplary embodiments of one or more P/PoP configured to interconnect and enforce a policy between a plurality of entities and a network environment therefor are described in U.S. patent application Ser. No. 13/910,609 entitled SYSTEM AND METHOD FOR PROVIDING A SINGLE GLOBAL BORDERLESS VIRTUAL PERIMETER THROUGH DISTRIBUTED POINTS OF PRESENCE and filed on Jun. 5, 2013, the entirety of which is incorporated by reference herein. Further exemplary embodiments of P/PoPs and network environments therefor are described in U.S. patent application Ser. No. 13/828,296 entitled SYSTEM AND METHOD FOR CONTROLLING, OBFUSCATING AND ANONYMIZING DATA AND SERVICES WHEN USING PROVIDER SERVICES and U.S. patent application Ser. No. 13/827,940 entitled NETWORK SYSTEM AND METHOD FOR IMPROVING ROUTING CAPABILITY the entirety of each of which are incorporated by reference hereby.

In an embodiment, the one or more P/PoP further comprises: a Sequencer, layer that provides traffic direction.

According to another embodiment, the plurality of interconnected entities provide an application which is a collection of the functions provided by each of the plurality of entities.

According to another embodiment, each service area is configured to perform at least one of a plurality of actions with respect to the received data.

According to another embodiment, the one or more Perimeter Points of Presence (P/PoP) are configured to process the received data in parallel, serially, or both.

According to another embodiment, the received data is communicated from an unknown source, the unknown source being an entity beyond the organizational control of an entity associated with the customized virtual perimeter.

According to another embodiment, the received data from the unknown source is transmitted by the one or more P/PoP as policy compliant data to one or more known or unknown destinations or both.

According to an embodiment, the received data is communicated from a known source, the known source being an entity within the organizational control of the entity associated with the customized virtual perimeter.

According to an embodiment, the received data from the known source is communicated through the one or more P/PoP as policy compliant data to one or more known or unknown destinations or both.

According to an embodiment, the one or more P/PoP is configured to leverage a physical connection comprising a dedicated physical connection to connect to the one or more P/PoPs to facilitate communications through the one or more P/PoP to other destinations.

According to an embodiment, the one or more P/PoP is configured to leverage a virtual connection comprising a long-term or temporary virtual connection over private networks, public networks, or both to connect to the one or more P/PoP to facilitate communications through the one or more P/PoP to other destinations.

According to an embodiment, the one or more P/PoP is configured to leverage a controlled connection when communication is limited to flow through one or more P/PoP via implemented controls.

According to an embodiment, the P/PoP is configured to simultaneously leverage physical, virtual and controlled connections, the configuration comprising at least one of: the physical, virtual and controlled connections as components of a single connection, and to connect to the one or more P/PoP to facilitate communications through the one or more P/PoP to other destinations.

According to an embodiment, the entities are interconnected via one or more connection selected from a plurality of connections comprising a group of private physical connection, public connection, hybrid connection, private virtual connection over a public medium or network, private virtual connection over a hybrid medium or network, and private virtual connection over a private medium or network.

According to an embodiment, the plurality of entities comprising: a computer platform, a data center, a plurality of providers of virtualized service, a cloud instance, a mobile device, a remote user, and an access end-point.

According to an embodiment, the plurality of providers of virtualized service includes a provider of virtualized authentication services, a provider of virtualized database services, a provider of virtualized web services, a provider of virtualized middleware services, a provider of virtualized content delivery services, and a provider of virtualized web hosting services.

According to an embodiment, the plurality of functions layers includes one or more function layers selected from a plurality of function layers comprising the group of: application delivery and resiliency layer, visibility and assessment layer, security and privacy layer, acceleration layer, and anonymity layer.

According to another embodiment all of the above functions are administered via a provisioning infrastructure, management infrastructure, a logging and reporting infrastructure and a metering and billing infrastructure for each respected function.

Embodiments also comprise a method implemented by at least one computer comprising a processor, non-transitory memory, and a computer readable medium storing thereon computer code thereon, wherein the computer is configured to perform at least: accepting network connections at one or more Perimeter Points of Presence (P/PoP) configured to interconnect a plurality of entities including at least one entity associated with a customized virtual perimeter, each of the plurality of entities providing at least one function; receiving a data flow from a data source at the one or more Perimeter Points of Presence (P/PoP); processing the data using at least one of function layers configured as a data processing policy for the entity; and transmitting the processed data flow as policy compliant data flow from the one or more Perimeter Points of Presence (P/PoP) to an end point, wherein the customized virtual perimeter comprises selectable function layers for creating the policy.

### BRIEF DESCRIPTION OF DRAWINGS

FIG. 1A illustrates an exemplary structure of a P/PoP of a geographically distributed interconnected platform according to an embodiment of the present disclosure.

FIG. 1B illustrates an exemplary embodiment of administrative infrastructures in a distributed infrastructure.

FIGS. 2A-2B illustrates an example of interconnectivity between one or more P/PoPs according to an embodiment of the present disclosure and exemplary systems and subsystems therefor.

FIG. 3 illustrates an example of connectivity between functionality providers and P/PoPs according to an embodiment of the present disclosure.

FIG. 4 illustrates a system in which a plurality of tiers involved in a data flow according to an embodiment of the present disclosure.

FIG. 5A illustrates an example of end-to-end data flow for the entire system according to an embodiment of the present disclosure.

FIG. 5B illustrates another example of end-to-end data flow for the entire system according to an embodiment of the present disclosure.

FIG. 6 illustrates a system in which redundant P/PoPs support one or more providers according to an embodiment of the present disclosure.

FIG. 7 illustrates an example of redundant connections to redundant P/PoPs delivering redundant paths, to redundant providers according to an embodiment of the present disclosure.

FIG. 8 illustrates another example of end-to-end data flow scenario for the entire system according to an embodiment of the present disclosure.

FIG. 9 illustrates another example of end-to-end data flow scenario for part of the system according to an embodiment of the present disclosure.

FIG. 10 illustrates another example of end-to-end data flow scenario for where some elements of the communications utilize other means of communications according to an embodiment of the present disclosure.

FIG. 11 illustrates another example of end-to-end data flow scenario for a client/server application model according to an embodiment of the present disclosure.

FIG. 12 illustrates an exemplary structure of a server, system, or a terminal according to an embodiment.

### DETAILED DESCRIPTION OF EMBODIMENTS

It is to be understood that the figures and descriptions of the present embodiments of the invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

Described are embodiments for system, method, and computer readable medium for interconnecting a plurality of entities, each of which provides at least one function, utilizing a network system including a computer, a processor, memory, and a computer readable medium storing thereon computer code which when executed by the at least one computer causes the at least one computer to at least: interconnect one or more entities geographically distributed with a plurality of computer platforms and a plurality of access end-points.

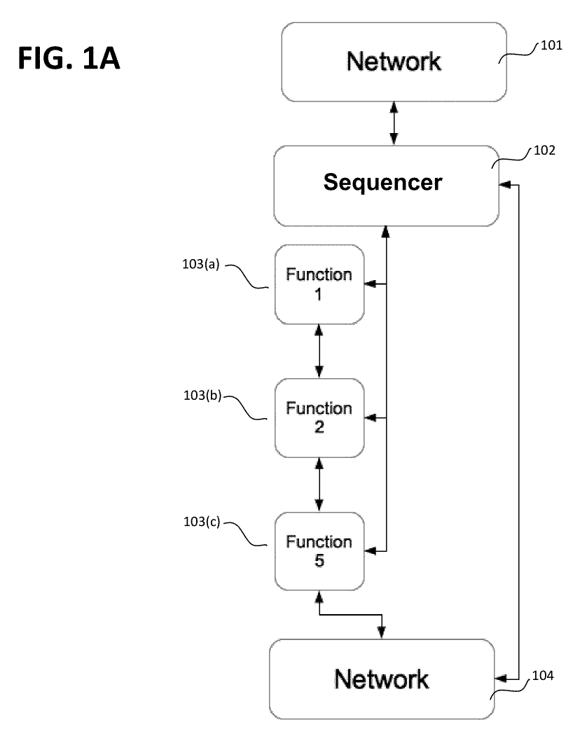

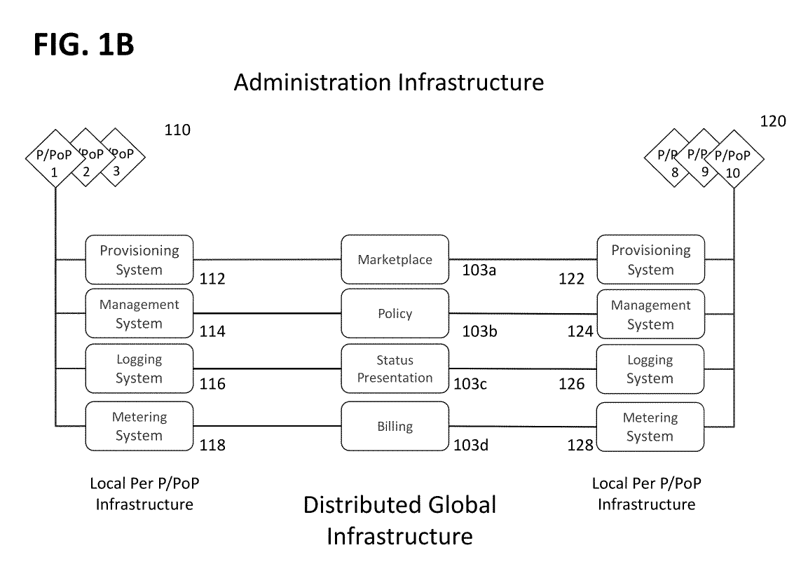

The present system comprises a geographically distributed interconnected platform that may be connected to other public (e.g., Internet), hybrid (e.g., Community), or private networks. This platform comprises one or more Perimeter Points of Presence (P/PoP). FIG. 1A illustrates an exemplary structure of a P/PoP of a geographically distributed interconnected platform. As shown in FIG. 1A, the data flow is transmitted from a known or unknown party via network 101 to a Sequencer layer 102, and then transmitted to one or more function layers 103(a)-103(c) for processing the data. Then the processed data flow is sent to network 104 to a destination. As will be appreciated, the systems and subsystems process both inbound and outbound data flows in both directions.

Each of the networks 101 and 104 can support physical or virtual connections. Exemplary network architecture includes Layer 1 (Physical Layer), Layer 2 (Transport Layer), and Layer 3 (Network Layer). As is understood by in the art, packets used in computer network communications contain the originator's source address and the recipient's destination address. Packets are then directed through a variety of devices that make up the network infrastructure. This applies to the Transport Layer (Layer 2) and the Network Layer (Layer 3) through the use of addresses such as MAC and IP addresses or their equivalents. Network infrastructure devices haul these packets throughout the network utilizing various lists to determine how to direct packets to these destinations. These lists can be defined statically or learned from other network infrastructure devices through dynamic means such as routing protocols, (for example, Border Gateway Protocol (BGP)), from other network infrastructure devices that share the devices' known paths to various destinations.

The Sequencer Layer 102 provides traffic direction based on various factors including but not limited to:
Source/Destination
Port Protocol
Application Protocol
Application
User ID
Path
Latency

Each of the functions layers 103(a)-103(c) provides one or more resources that can assess and or take action on the flow and or the data including but not limited to:
Application Delivery and Resiliency to ensure service and functional availability of various internal and external systems and functions, along with the redirection of traffic flows in the event of availability or performance concerns associated with traffic flow destinations.
Visibility and assessment to offer insight into and records of communications, utilization and normal and abnormal event(s).
Security and Privacy to ensure system and data integrity as defined by the entities policy along with an action in the event the traffic flow and or associated data is found to not adhere to the policy.
Acceleration to facilitate the optimization of an application or function's performance to support an enhanced user experience.
Anonymity to mask the identity of the source and or destination of a communication between various tiers and various providers of virtualized services.

According to an embodiment, multiple interconnected P/PoPs may operate in distributed geographies or by control domains (i.e., multiple P/PoPs may exist within a single building or even data center, but be considered separate based on organizational and or control boundaries.) Interconnection between the P/PoPs may consist of:
Physical connection(s) comprised of dedicated and or private connectivity such as a dedicated circuit, optical wave or tagged Virtual Local Area Network (ULAN) framework for instance.
Virtual connection(s) where the data flow and or the content destined to and from the P/PoP is encapsulated via a variety of standard and or non-standard means such as IP/Sec VPN, SSL Tunnels, and Generic Routing Encapsulation (GRE).
Controlled connection where communications to and from the end-user/end-device (including networks), and or service is limited to flow through a P/PoP via implemented controls. For example an access control is implemented on a publicly accessible cloud instance to limit traffic to that instance to be sourced from one or more defined P/PoPs and traffic from that instance to be destined only to one or more defined P/PoPs.

According to another embodiment, any or all functions 103(a)-103(d) can be administered by system infrastructures for the respective functions in distributed geographies or control domains as described herein. For example, an embodiment of administrative infrastructures in a distributed environment is shown in FIG. 1B. As shown, one group of P/PoPs 110 are connected to administrative systems, for example, a provisioning system 112, management system 114, a logging system 116 and a metering system 118, which in turn support respective functions 103(a)-103(d). As shown, the provisioning system 112 supports a marketplace function 103(a), management system 114 supports a policy function 103 (b), a logging system 116 supports a reporting function 103(a) (“Status Presentation”) and a metering system 118 supports a billing function 103(d). Another group of P/PoPs 120 are also connected to a separate provisioning system 122, management system 124, a logging system 126 and metering system 128. These separate systems also support the marketplace function 103(a), the policy function 103(b), the reporting function 103(a) (“Status Presentation”) and the billing function 103(d). The administrative support for functions or other systems or components described above can be centralized systems or distributed components or combinations thereof as described for embodiments herein.

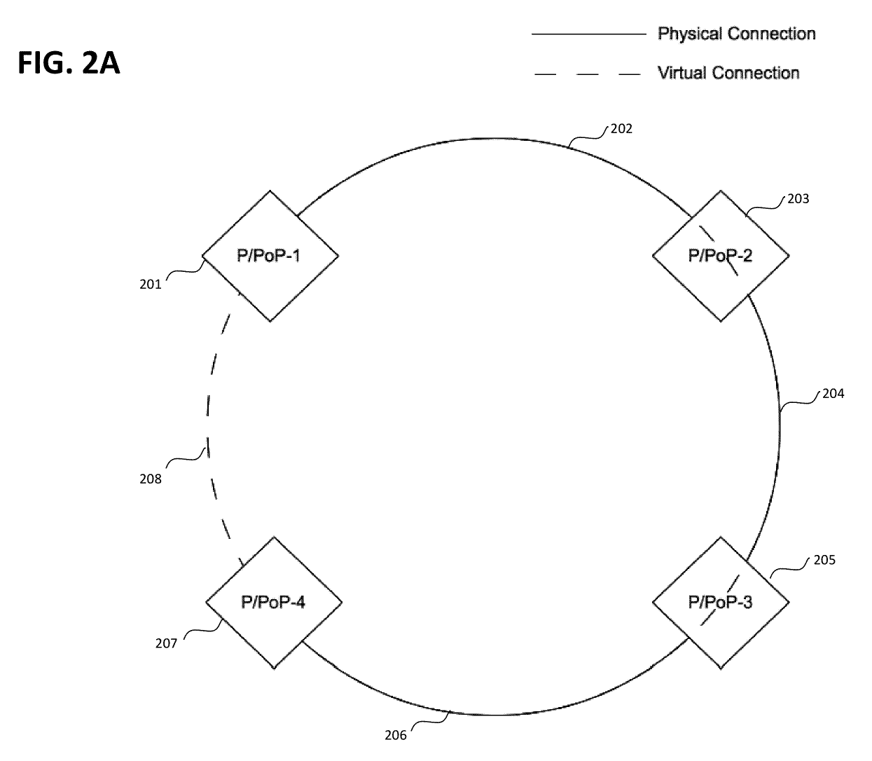

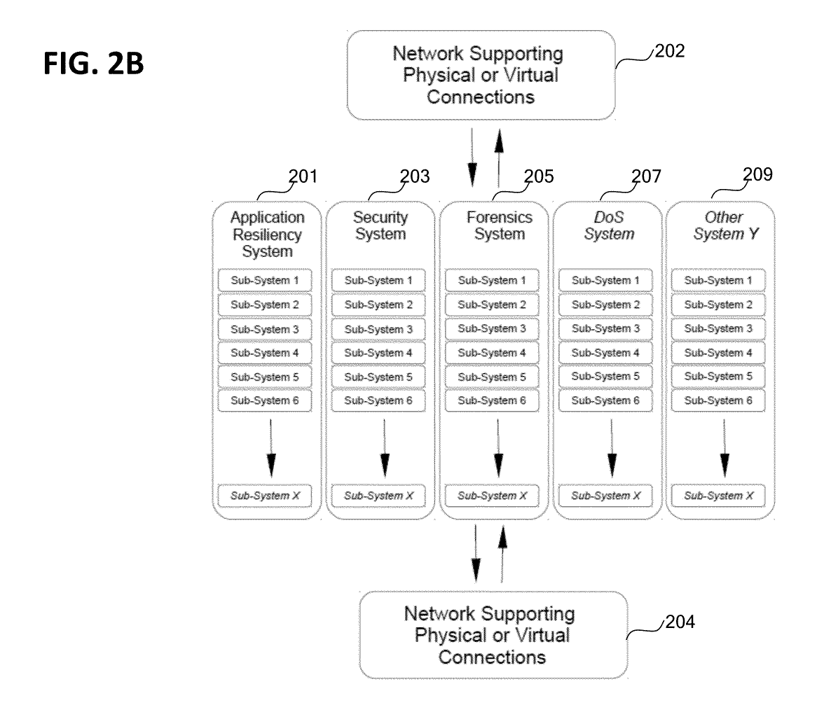

FIG. 2A illustrates an example of interconnectivity between one or more P/PoPs according to an embodiment of the present disclosure. As shown in FIG. 2A, the system comprises one or more P/PoP 201, 203, 205, 207 that can be geographically distributed, for example, across multiple buildings, cities, regions, countries, and continents. The P/PoP 201, 203, 205 and 207 are interconnected. For example, the P/PoP 201, 203, 205 and 207 may be fully interconnected, i.e., P/PoP-1 201 is connected to P/PoP-2 203 via physical connection 202, P/PoP-2 203 is connected to P/PoP-3 205 via physical connection 204, P/PoP-3 205 is connected to P/PoP-4 207 via physical connection 206, and P/PoP-4 207 is connected to P/PoP-1 201 via virtual physical connection 208.

Alternatively, the Perimeter Points of Presence 201, 203, 205 and 207 may be partially interconnected connected, i.e., P/PoP-1 201 is connected to P/PoP-2 203 via physical connection 202, P/PoP-2 203 is connected to P/PoP-3 205 via physical connection 204, and P/PoP-3 205 is connected to P/PoP-4 207 via physical connection 206, however P/PoP-4 207 may not be connected (not shown). Alternatively, one or more of the Perimeter Points of Presence (P/PoP) 201, 203, 205 and 207 may operate autonomously without any interconnection (non shown).

FIG. 2B illustrates a multitude of systems and associated sub-systems utilized in the delivery of virtual perimeter for processing data for functions for an application or to execute processes for implementing an application. As shown in FIG. 2B, the communication flow is transmitted from a known or unknown party via network connections 202 to one or more Perimeter Points of Presence (P/PoP) 201, 203, 205, 207, 209 that comprise a plurality of systems for processing the data. Examples of systems include systems such as application resiliency system 201, security system 203, forensics system 205, DoS Protection System 207, and system Y 209, etc, which are included in the one or more Perimeter Points of Presence (P/PoP). Then the processed communication flow is sent via a network connection 204 to a destination. As will be appreciated, the systems and subsystems process both inbound and outbound data flows in both directions. Each of the networks 202 and 204 supports physical or virtual connections as described herein.

Each of the plurality of systems 2204, 203, 205, 207, 209 comprises sub-system 1, sub-system 2, sub-system 3 . . . sub-system x, etc. Each P/PoP comprises components in each of the service areas such as network, security, application resiliency and availability, and application acceleration. Each of the service areas may comprise one or more functional technologies. For example the security service area may comprises the following capabilities across shared or distributed subsystems, or each of the following security capabilities may represent a sub-system function:
network port and protocol stateful control;
application layer control;
deep packet inspection;
threat management;
user and device identification and validation;
content filtering
encryption (Site-to-Site encryption, Device to site encryption, Device to Device, Person to Person, etc.)
decryption
re-encryption

Application resiliency and availability service area may comprise the following capabilities across shared or distributed sub-systems:
System availability monitoring
System port monitoring
System application function and availability monitoring
Communication distribution between multiple systems
Application redirection in the event of system, port, or application unavailability
Application load sharing between multiple sites
Application connection re-use
Application acceleration

Unlike other services in prior art that only support single network protocols, such as http, the system described in the present invention supports every port, protocol, and application regardless of location, geography, type of network, type of access (Layer 1, Layer 2, or Layer 3), means of access, operating system, and application.

According to an embodiment, computing nodes leverage one or more P/PoP(s) as a virtual perimeter by allowing inbound and outbound path for data flow by:

(a) building a connection comprising:
i. Physical connection—leveraging a physical connection to one or more P/PoP(s).
ii. Virtual connection—leveraging a site-to-site or device-to-site tunneling technology to connect to one or more P/PoP(s). A virtual connection leverages by encapsulating the communication for traversal across any network such as public, private or community such as SSL (Secure Sockets Layer), IPSec VPN (Internet Protocol Security Virtual Private Network), or GRE (Generic Routing Encapsulation) or similarly functioned technology.
(b) Utilizing one or more P/PoP(s) as virtual perimeter for an application or system, where the P/PoP(s) acts as a public or private point of access to the application or system. The connection to the P/PoP(s) may or may not be encrypted between the P/PoP(s) and the computing node may or may not be tunneled over a public mediums such as the Internet, third-party connections or other hybrid connections.

According to an embodiment, distributed access end-points may also leverage one or more P/PoP(s) as a virtual perimeter by allowing inbound and outbound path for data flow by:

(a) Building a connection comprising:
i. Physical connection—leveraging a physical connection to one or more P/PoP(s).
ii. Virtual connection—leveraging a site-to-site or device-to-site tunneling technology to connect to one or more P/PoP(s) such as IPSec, SSL VPN, or GRE tunneling.

(b) Utilizing one or more P/PoP(s) as virtual perimeter for an application or system, where the P/PoP(s) acts as a public point of access to the application or system. The connection to the P/PoP(s) may or may not be encrypted and the between the P/PoP(s) and the computing node may or may not be tunneled over a public mediums such as the Internet, third-party connections or other hybrid connections.

All communications inbound and outbound flow through one or more P/PoP(s) where all communications may be subject to one or more functions such as connection, interconnection, control, protection, privacy, application resiliency, DoS protection, monitoring, centralized management and other functions are applied prior to being passed to the destination.

According to an embodiment, the system described in the present invention virtualizes the perimeter into a globally distributed P/PoPs (Perimeter Points of Presence). These P/PoPs normally operate as part of a collective, though may also function autonomously. Each P/PoP supports various elements including:

(a) a network consisting of distributed control and data plane;

(b) virtualized systems and associated functional sub-systems. Though embodiments for network, security, and application resiliency have been specifically described in this document, any perimeter function such as forensics, data leakage prevention, and many other functions can be virtualized and delivered as a service across multiple disparate sites via application delivery policy with this model;

(c) specific flows can be defined on a per organization, per end-user, per device and or per application basis among others. These are referred to as a virtual instance. These virtual instances can leverage one or more systems and sub-systems in several ways: serial communication flows, parallel communication flows, and hybrid communication flows.

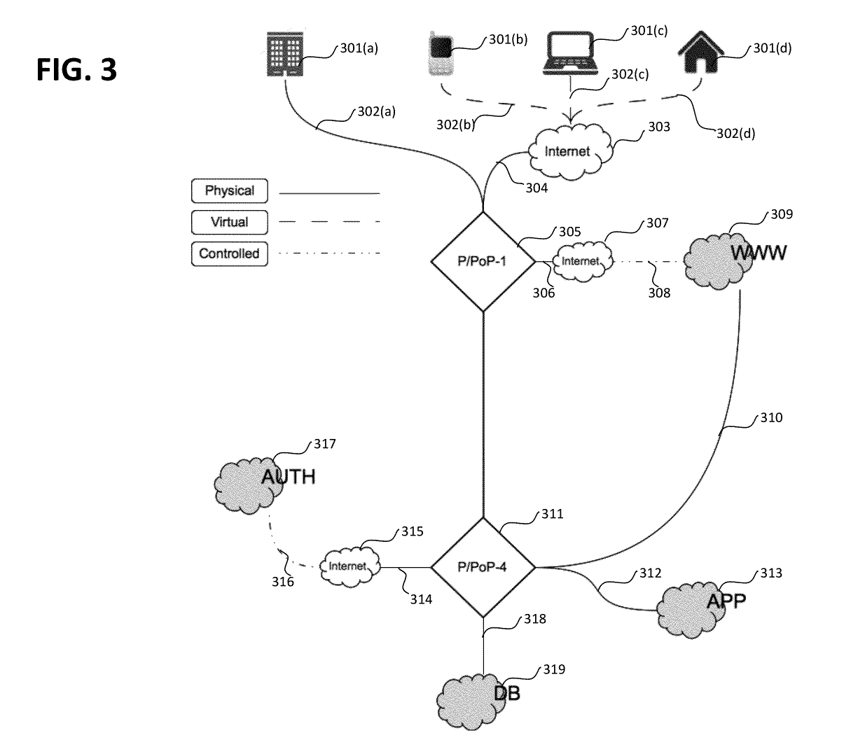

FIG. 3 illustrates an example of connectivity between functionality providers and P/PoPs according to an embodiment of the present disclosure. For example, an end device 301(a) is connected to P/PoP-1 305 via physical connection 302(a). End devices 301(b)-301(d) is connected to internet 303 via virtual connection 302(b)-302(d), respectively, and internet 303 is connected to P/PoP-1 305 via physical connection 304. P/PoP-1 305 is connected to internet 307 via physical connection 306, and internet 307 is connected to a web server 309 via controlled connection 308. The web server 309 is connected, via physical connection 310, to P/PoP-3 311, which is connected to an application server 313 via physical connection 312. The P/PoP-3 311 is also connected, via physical connection 314, to internet 315, which is connected to a provider of virtualized authentication services 317 via controlled connection 316. And a provider of virtualized Database services 319 is connected to P/PoP-3 311 via physical connection 318.

As will be appreciated, FIGS. 2-3 show exemplary non-limiting examples of possible physical, virtual and controlled connections between known and unknown entities and the Perimeter Points of Presence, however connections between any given entity and the Perimeter Points of Presence can be either physical, virtual, controlled or all as the Perimeter Points of Presence are configured to accept all such connections as described herein. For example, an entity may have one or more direct or indirect connections to the P/PoP, including any or all of a dedicated physical connection, a virtual connection, and/or a single path connection where a virtual connection and physical connection are components thereof.

According to an embodiment, the present system provides the capabilities to:

1. Implement an interconnection between known and or unknown parties, networks, computer resources, and or devices. This interconnection can be via:
Private physical connection
Public connection
Hybrid (community) connection
Private virtual connection over a public medium or network
Private virtual connection over a hybrid medium or network
Private virtual connection over a private medium or network
Any combination of the above

2. Implement policy-based static or dynamic visibility, assessment, controls, along with flow and or data manipulations at one or more points of enforcement.

3. Establish defined or dynamic data flow that allow multiple tiers of access where each tier represents a layer of communication (e.g. interconnection implementation 1 above) along with associated visibility and controls (e.g. enforcement implementation as shown in 2 above) based on static data flows or as driven by dynamic events.

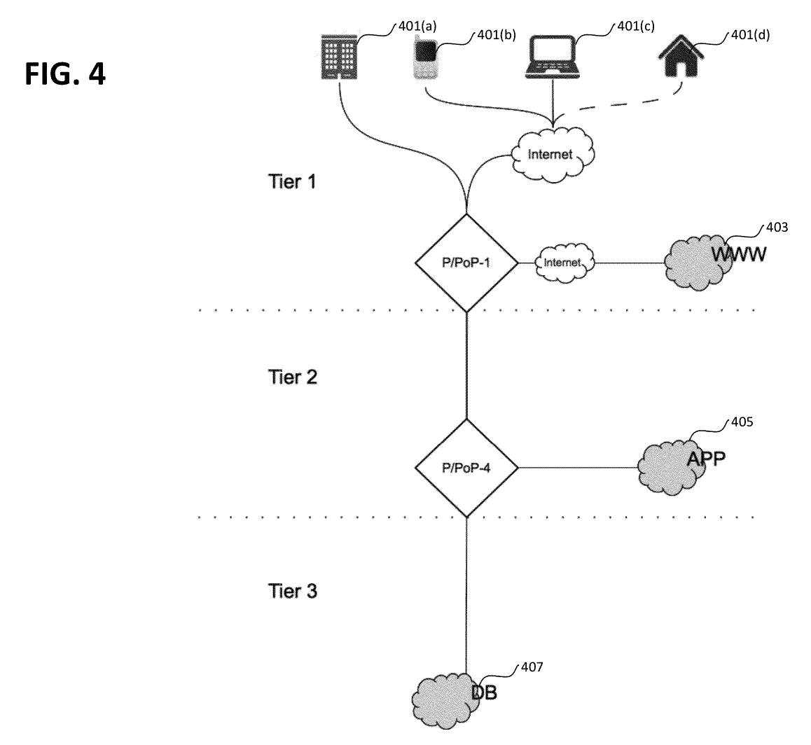

FIG. 4 illustrates a system in which a plurality of tiers involved in a data flow according to an embodiment of the present disclosure. A Tier refers to a process and components therefor for interconnecting, communicating, orchestrating, and or delivering functionalities via a data flow between sources and destinations. As shown in FIG. 4, one or more Tiers are involved in a common application delivery scenario. For example, the elements of interconnecting, orchestrating, applying and enforcing policy, which may include policy-based visibility, assessment, data and path manipulation and or enforcement, between end devices 401(a)-401(d) of an end-user and a web server 403 is considered as Tier 1. The process of interconnecting, orchestrating, applying and enforcing policy which may include visibility, assessment, data and path manipulation or enforcement policy-based visibility, assessment, data and path manipulation or enforcement between the web server 403 and an application server 405 is Tier 2. The process of interconnecting, orchestrating, applying and enforcing policy which may include policy-based visibility, assessment, data and path manipulation or enforcement, and a data flow between the application server 405 and a database server 407 is Tier 3.

Accordingly, the present system can provide a variety of methods for interconnecting, a variety of functions for policy-based visibility, assessment, static or dynamic data and path manipulation and or enforcement, which may consist of one or more tiers between multiple disparate providers of functionality, software, applications, networks, data centers, devices, users, and or service provider via one or more P/PoPs. There is no inherent limitation in:
Number or type of P/PoPs that can leveraged in a single tier or across multiple tiers that make up an application.
Number of tiers that can be supported within the architecture of an application.
Type or number of functions that can be supported as a part of the Sequencer layer.
Type or number of disparate visibility, assessment, controls, enforcement, data flows and or data and path manipulations that the Sequencer layer supports.
Type or number of disparate visibility, assessment, controls, enforcement, data flows and or data and path manipulations that the functions layer supports.
The combination of providers of functionality, software/application-as-a-service, data center, and or service providers that can be supported.

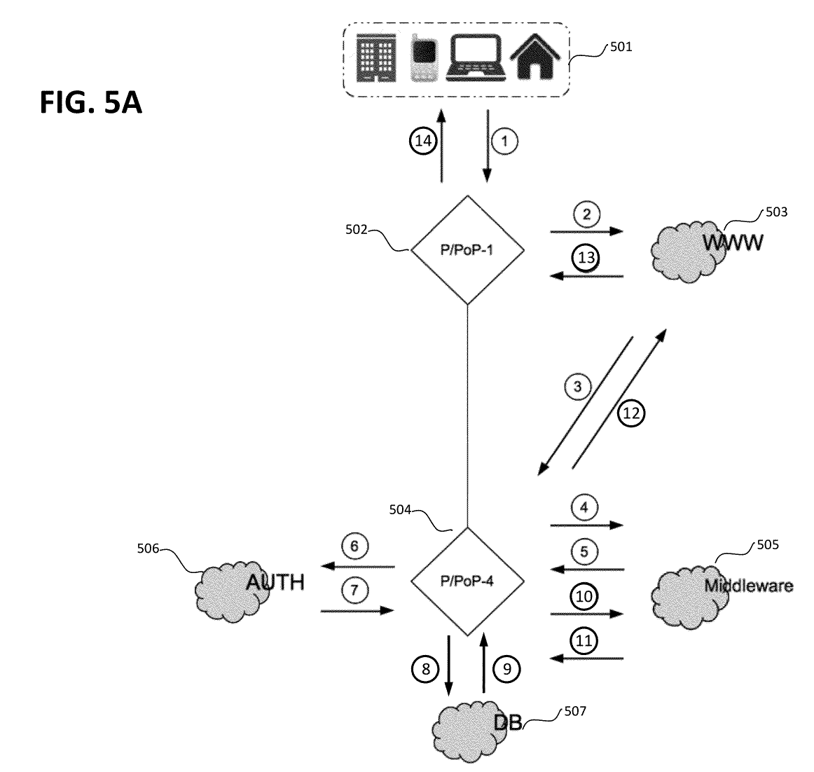

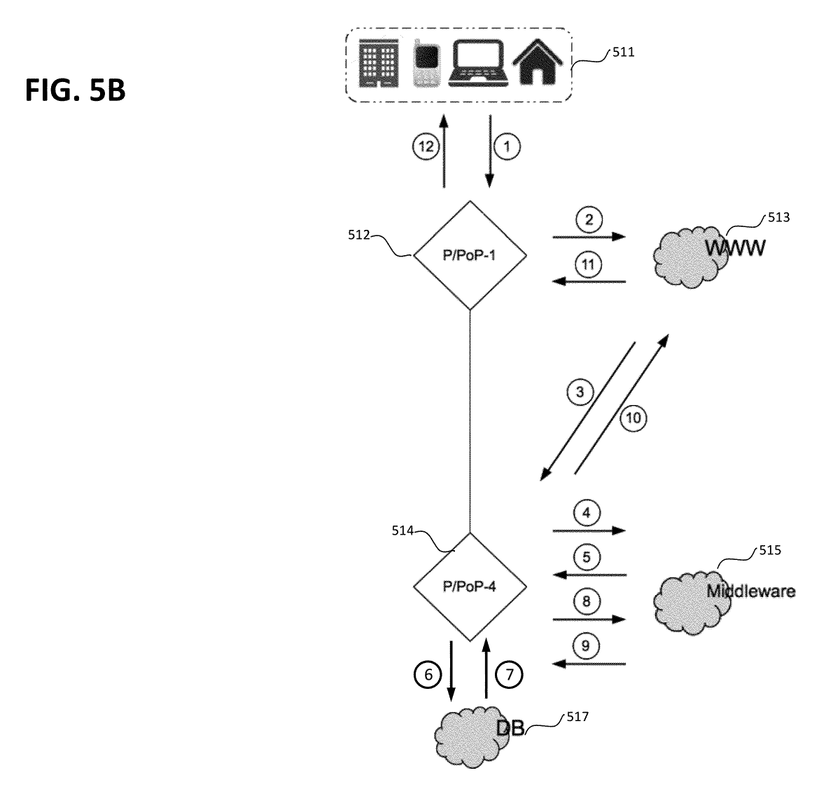

FIG. 5A illustrates an example of end-to-end data flow for the entire system for authenticating a user to an application comprised of providers of functionality according to an embodiment of the present disclosure. For example, as shown in the data flow transmission steps 1-2, the system facilitates the initial communications and policy enforcement between an end-user/end-device 501 and a disparate front-end functionality or application provider such as a provider of virtualized web services 503 over a public network through P/PoP-1 502, in order that the provider of virtualized web services 503 performs its function. The provider of virtualized web services 503 may, however require functionality from a provider of virtualized Middleware services 505 via a disparate middleware provider. Accordingly, as shown in the data flow transmission steps 3-4, the communication for the provider of virtualized Web services 503 is then facilitated via a physical, virtual, or controlled connection by the same or different P/PoP, for example P/PoP-4 504 where a unique policy is enforced between the front-end provider of virtualized Web services 503 and a disparate provider of virtualized Middleware services 505 in order that the virtualized Middleware services 505 can perform its function.

The virtualized Middleware services 505 provider, however, may be dependent on directory services functionality from a disparate provider of virtualized Authentication services 506. Accordingly, as shown in the data flow transmission steps 5-6, the communication for the provider of virtualized Middleware services 505 is then facilitated via a physical, virtual, or controlled connection by the same or different P/PoP, for example, P/PoP-4 504 where a unique policy is enforced between the provider of virtualized Middleware services 505 and a disparate provider of virtualized Authentication services 506 that then performs its function which may be dependent on access to data from a customer user directory database 507 at a disparate location.

As shown in the data flow transmission steps 7-8, the communication for the provider of virtualized Authentication services 506 is then facilitated via a physical, virtual, or controlled connection by the same or different P/PoP, for example, P/PoP-4 504 where a unique policy is enforced between the provider of virtualized Authentication services 506 and the customer's user directory database 507.

As shown in the data flow transmission steps 9-10, the customer's user directory database 507 responds to the provider of virtualized Middleware services 505 via the same or different P/PoP, for example, P/PoP-4 504 where a unique policy is enforced between the customer and the middle-ware provider 505.

As shown in the data flow transmission steps 11-12, after the provider of virtualized Middleware services 505 receives the customer data, the provider of virtualized Middleware services 505 responds to the provider of virtualized Web services 503 by the same or a different P/PoP, for example, P/PoP-4 504 where a unique policy is enforced between the provider of virtualized Middleware services 505 and the provider of virtualized Web services 503.

As shown in the data flow transmission steps 13-14, the provider of virtualized Web services 503 with its query complete now responds to the end-user/end-device 501 by the same or different P/PoP, for example, P/PoP-1 502, either validating or rejecting the authentication attempt.

In the above example communications and policy enforcement were facilitated between users, devices, disparate provider of functionality services, as well as the entity with the ownership of the overall system, their software and database.

FIG. 5B illustrates an example of end-to-end data flow for the virtual data center functionality, when the authentication attempt in the above example shown in FIG. 5A is successful according to an embodiment of the present disclosure. For example, as shown in the data flow transmission steps 1-2, the system facilitates the communication and policy enforcement from the end-user/end-device 511 via any participating P/PoP, for example, P/PoP-1 512 to the provider of virtualized Web services 513 over a public network, where the provider of virtualized Web services 513 can then perform its function, which may require functionality from a disparate provider of virtualized Middleware services 515. Accordingly, as shown in the data flow transmission steps 3-4, the communication for provider of virtualized Web services 513 is then facilitated via a physical, virtual, or controlled connection by the same or different P/PoP, for example, P/PoP-4 514 where a unique policy is enforced between the front-end provider of virtualized Web services 513 and a disparate provider of virtualized Middleware services 515 in order that it can performs its function.

The virtualized Middleware services 515 may require data from a provider of virtualized Database services 517. Accordingly, s shown in the data flow transmission steps 5-6, the communication for the provider of virtualized Middleware services 515 is then facilitated via a physical, virtual, or controlled connection by the same or different P/PoP, for example, P/PoP-4 514 where a unique policy is enforced between the provider of virtualized Middleware services 515 and a disparate provider of virtualized Database services 517. As shown in the data flow transmission steps 7-8, the disparate provider of virtualized Database services 517 then performs its function and responds to the provider of virtualized Middleware services 515 via the same or different P/PoP, for example, P/PoP-4 514 where a unique policy is enforced between the provider of virtualized Database services 517 and the provider of virtualized Middleware services 515.

As shown in the data flow transmission steps 9-10, after the provider of virtualized Middleware services 515 receives the data from the provider of virtualized Database services 517, the provider of virtualized Middleware services 515 performs its function to respond back to the provider of virtualized Web services 513. The communication for provider of virtualized Middleware services 515 is then facilitated via a physical, virtual, or controlled connection by the same or different P/PoP, for example, P/PoP-4 514 where a unique policy is enforced between the provider of virtualized Middleware services 515 and provider of virtualized Web services 513.

As shown in the data flow transmission steps 11-12, after the provider of virtualized Web services 513 receives the response from the provider of virtualized Middleware services 515, the provider of virtualized Web services 513 performs its function and responds to the end-user/end-device 511. The communication for provider of virtualized Web services 513 is facilitated via a physical, virtual, or controlled connection by the same or different P/PoP, for example, P/PoP-1 512 where a unique policy is enforced between the provider of virtualized Web services 513 and end-user/end-device 511.

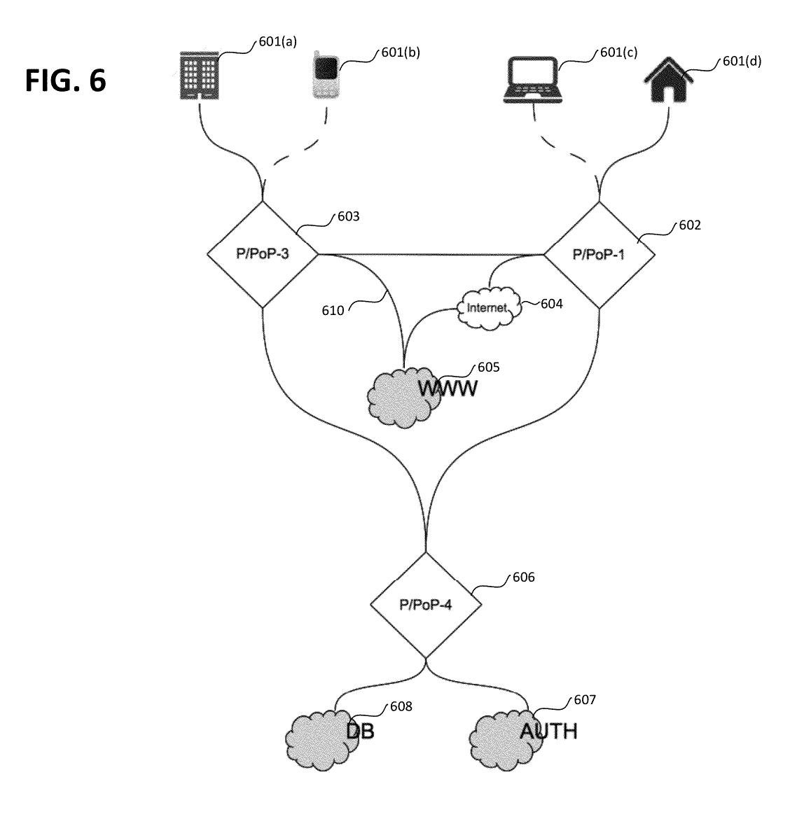

According to an embodiment, multiple P/PoPs may simultaneously support a single provider of a functionality or application. This may be useful to support redundancy, load levels, or for optimized geographic reachability. FIG. 6 illustrates a system in which redundant P/PoPs support one or more providers according to an embodiment of the present disclosure. As shown in FIG. 6, end-users/end-devices 601(a)-601(d) may be connected to P/PoP-1 602 or P/PoP-3 603 to access the functionality provided by the provider of virtualized Web services 605. It should be noted that the P/PoP availability in this example can take many forms including:

1. P/PoP-1 602 as primary and P/PoP-3 603 as failover backup, which means that all traffic will be directed to P/PoP-1 602 unless it becomes unavailable at which point P/PoP-3 603 will become primary.

2. P/PoP-1 602 as primary and P/PoP-3 603 as active backup, which means that most of the traffic will be directed to P/PoP-1 602 and some traffic will be directed to P/PoP-3 603. In the event P/PoP-1 602 becomes unavailable, then P/PoP-3 603 will support all traffic. In the event P/PoP-3 603 becomes unavailable, then P/PoP-1 602 will support all traffic.

3. P/PoP-3 603 as primary and P/PoP-1 602 as failover backup, which means that all traffic will be directed to P/PoP-3 603 unless it becomes unavailable at which point P/PoP-1 602 will become primary.

4. P/PoP-3 603 as primary and P/PoP-1 602 as active backup, which means that most of the traffic will be directed to P/PoP-3 603 and some traffic will be directed to P/PoP-1 602. In the event P/PoP-3 603 becomes unavailable, then P/PoP-1 602 will support all traffic. In the event P/PoP-1 602 becomes unavailable, then P/PoP-3 603 will support all traffic.

5. P/PoP-1 602 and P/PoP-3 603 both as primary with the ability split active traffic between them based on a number of factors including but not limited to:
Source and or destination route distance
Source and or destination latency
P/PoP and or provider performance and load levels
Static designations
Dynamic events

In the event P/PoP-1 602 becomes unavailable all traffic will be directed to P/PoP-3 603. If P/PoP-3 603 becomes unavailable all traffic will be directed to P/PoP-1 602.

The interconnection of multiple P/PoPs may be physical, virtual, controlled or any combination of above connections while retaining full functionality. For example, as shown in FIG. 6, the interconnection from P/PoP-1 602 to a provider of virtualized Web services 605 is over a public network 604, and the interconnect from P/PoP-3 603 to the provider of virtualized Web services 605 is via a physical connection 610.

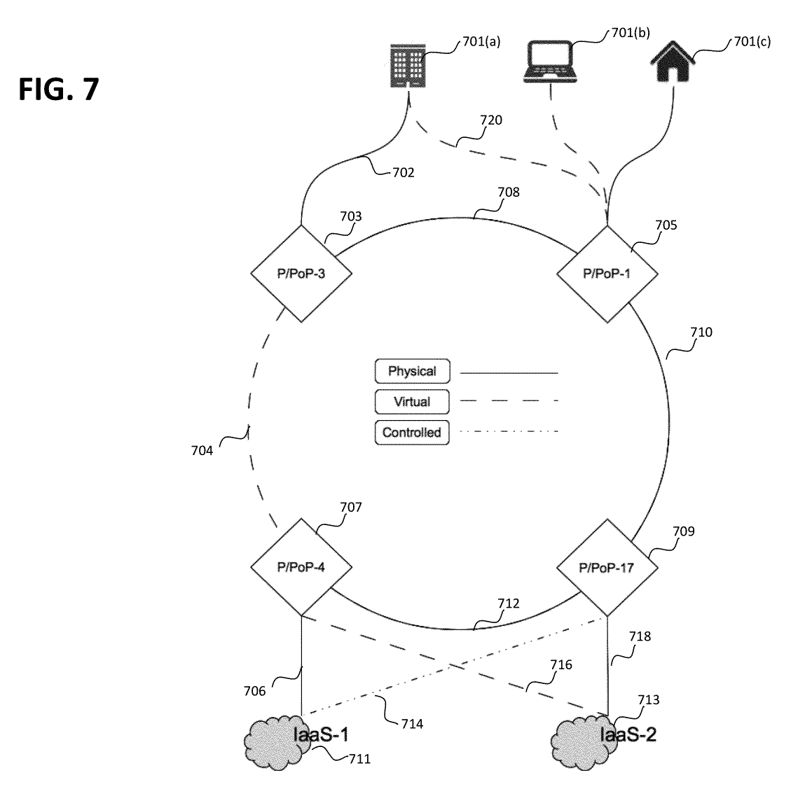

FIG. 7 illustrates an example of redundant connections to redundant P/PoPs delivering redundant paths, to redundant providers according to an embodiment of the present disclosure. As shown in FIG. 7, the system provides capability for multiple end-points, with multiple connections, using multiple connection types, to multiple P/PoPs, to support multiple providers of functionality. Moreover, in this scenario the end-user/end-device is not directly connected to the P/PoP that supports the providers interconnect and policy enforcement and the provider is not directly connected to the P/PoPs that support the end-user/end-device interconnect and policy enforcement.

As shown in FIG. 7, the office users and devices 701(a) are connected to P/PoP-3 703 via a physical connection 702 where their communication to provider of functionality services IaaS (Infrastructure as a Service), such as IaaS-1 711 and IaaS-2 713, flows over their private connection to P/PoP-3 703 where policy is enforced. Depending on their policy and or events the communications may:

(a) Flow through P/PoP-3 703 over the virtual connection 704 to P/PoP-4 707 to communicate with IaaS-1 711 via a physical connection 706, where another policy may optionally be enforced at P/PoP-4 707 prior to delivery to IaaS-1 711.

(b) Flow through P/PoP-3 703, then through P/PoP-1 705 via a physical connection 708, then through P/PoP-17 709 via a physical connection 710, then through P/PoP-4 707 via a physical connection 712 to communicate with IaaS-1 711 via a physical connection 706, where another policy may optionally be enforced at any of the P/PoPs prior to facilitating the communication to another P/PoP or delivery to IaaS-1 711.

(c) Flow through P/PoP-3 703, then through P/PoP-1 705 via a physical connection 708, then through P/PoP-17 709 via a physical connection 710 to communicate via a controlled connection 714 with IaaS-1 711, where another policy may optionally be enforced at any of the P/PoPs prior to facilitating the communication to another P/PoP or delivery to IaaS-1 711.

(d) Flow through P/PoP-3 703 over the virtual connection 704 to P/PoP-4 707 to communicate with IaaS-2 713 via a virtual connection 716, where another policy may optionally be enforced at P/PoP-4 707 prior to delivery to IaaS-2 713.

(e) Flow through P/PoP-3 703, then through P/PoP-4 707 via a virtual connection 704, then through P/PoP-17 709 via a physical connection 712 to communicate with IaaS-2 713 via a physical connection 718, where another policy may optionally be enforced at any of the P/PoPs prior to facilitating the communication to another P/PoP or delivery to IaaS-2 713.

(f) Flow through P/PoP-3 703, then through P/PoP-1 705 via a physical connection 708, to P/PoP-17 709 via a physical connection 710 to communicate via a physical connection 718 with IaaS-2 713, where another policy may optionally be enforced at any of the P/PoPs prior to facilitating the communication to another P/PoP or delivery to IaaS-2 713.

Alternatively, as shown in FIG. 7, the office users 701(a) may leverage a backup, redundant, and or additional virtual connection 720 to P/PoP-1 705 where policy is enforced to facilitate communication to IaaS-1 711 and IaaS-2 713 providers. Depending on their policy and or events the communications may:

(a) Flow through P/PoP-1 705, then through P/PoP-17 709 via a physical connection 710, to P/PoP-4 707 via a physical connection 712 to communicate with IaaS-1 711 via a physical connection 706, where another policy may optionally be enforced at any of the P/PoPs prior to facilitating the communication to another P/PoP or delivery to IaaS-1 711.

(b) Flow through P/PoP-1 705 to P/PoP-17 709 via a physical connection 710 to communicate with IaaS-1 711 via a controlled connection 714, where another policy may optionally be enforced at P/PoP-17 709 prior to delivery to IaaS-1 711.

(c) Flow through P/PoP-1 705, then though P/PoP-3 703 via a physical connection 708, then over the virtual connection 704 to P/PoP-4 707 to communicate with IaaS-1 711 via a physical connection 706, where another policy may optionally be enforced at any of the P/PoPs prior to facilitating the communication to another P/PoP or delivery to IaaS-1 711.

(d) Flow through P/PoP-1 705 to P/PoP-17 709 via a physical connection 710 to communicate with IaaS-2 713 via a physical connection 718, where another policy may optionally be enforced at P/PoP-17 709 prior to delivery to IaaS-2 713.

(e) Flow through P/PoP-1 705, though P/PoP-3 703 via a physical connection 708, then over the virtual connection 704 to P/PoP-4 707, to P/PoP-17 709 via a physical connection 712 to communicate with IaaS-2 713 via a physical connection 718, where another policy may optionally be enforced at any of the P/PoPs prior to facilitating the communication to another P/PoP or delivery to IaaS-2 713.

(f) Flow through P/PoP-1 705, then though P/PoP-3 703 via a physical connection 708, then over the virtual connection 704 to P/PoP-4 707 to communicate with IaaS-2 713 via a virtual connection 716, where another policy may optionally be enforced at any of the P/PoPs prior to facilitating the communication to another P/PoP or delivery to IaaS-2 713.

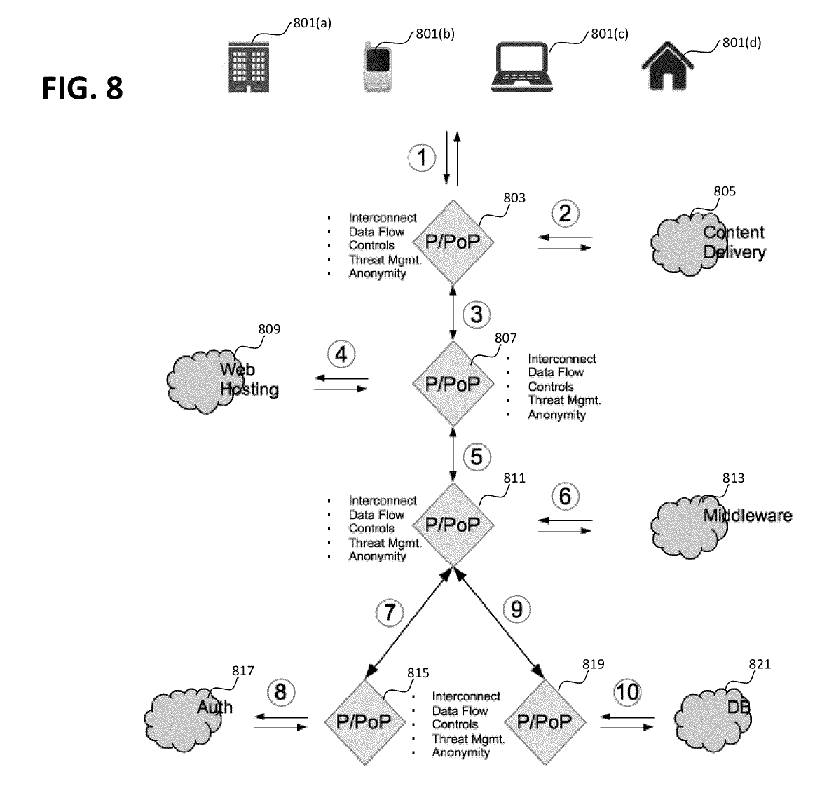

FIG. 8 illustrates another example of end-to-end data flow scenario for the entire system according to an embodiment of the present disclosure. As shown in FIG. 8, a example of scenario where office users 801(a), mobile device user 801(b), remote user 801(c), or home user 801(d) access a Virtual Data Center enabled application where as:

1. The application is advertised via one or more P/PoPs.

2. As shown in the data flow transmission processes 1-2, the client communication request passes through the P/PoP 803 that provides interconnect, data flow, controls, threat management and anonymity before the communications is forwarded to a provider of virtualized Content Delivery services 805.

3. As shown in the data flow transmission processes 2-3-4, the provider of virtualized Content Delivery services 805 then needs to fetch information from a provider of virtualized Web Hosting services 809. The communication flows through one or more P/PoPs, for example, P/PoPs 803 and 807, that provide interconnect, data flow, controls, threat management and anonymity before passed on to the provider of virtualized Web Hosting services 809.

4. As shown in the data flow transmission processes 4-5-6, the provider of virtualized Web Hosting services 809 may require some application logic that needs to be processed via a provider of virtualized Middleware services 813. Accordingly, the communication from the provider of virtualized Web Hosting services 809 flows through one or more P/PoPs, for example, P/PoPs 807 and 811, that provides interconnect, data flow, controls, threat management and anonymity before passed on to the provider of virtualized Middleware services 813.

5. As shown in the data flow transmission processes 6-7-8, the provider of virtualized Middleware services 813 may need to authenticate the user as well as determine the user's rights. The provider of virtualized Middleware services 813 requests user validation from a provider of virtualized Authentication services 817. The request flows through one or more P/PoPs, for example, P/PoPs 811 and 815, that provides interconnect, data flow, controls, threat management and anonymity before passing the request to the provider of virtualized Authentication services 817.

6. As shown in the data flow transmission processes 8-7-6, the provider of virtualized Authentication services 817 then responds to the provider of Middle-ware services 813 for validating the user. The response again flows through one or more P/PoPs, for example, P/PoPs 815 and 811, that provides interconnect, data flow, controls, threat management and anonymity before passing the request to the provider of virtualized Middleware services 813.

7. As shown in the data flow transmission processes 6-9-10, after receiving the information indicating that the user is a valid user, the provider of virtualized Middleware services 813 needs to get user rights information which is located in a database. The provider of virtualized Middleware services 813 requests this information from the provider of virtualized Database services 821 through one or more P/PoPs, for example, P/PoPs 811 and 819, which provides interconnect, data flow, controls, threat management and anonymity between the two resources.

8. As shown in the data flow transmission processes 10-9-6, the provider of virtualized Database services 821 responds to the provider of virtualized Middleware services 813 with the requested information through one or more P/PoPs, for example, P/PoPs 819 and 811, which provides interconnect, data flow, controls, threat management and anonymity between the two resources.

9. As shown in the data flow transmission processes 6-5-4, the provider of virtualized Middleware services 813 utilizes all the information to respond to the original request from the provider of virtualized Web Hosting services 809. This communications flows through one or more P/PoPs, for example, P/PoPs 811 and 807, that provides interconnect, data flow, controls, threat management and anonymity between the two resources.

10. As shown in the data flow transmission processes 4-3-2, the provider of virtualized Web Hosting services 809 responds to the original request from the provider of virtualized Content Delivery services 805. This communications flows through one or more P/PoPs, for example, P/PoPs 807 and 803, that provides interconnect, data flow, controls, threat management and anonymity between the two resources.

11. As shown in the data flow transmission processes 2-1, the provider of virtualized Content Delivery services 805 responds to the original request from the user. This communications flows through a P/PoP 803 that provides interconnect, data flow, controls, threat management and anonymity between the two resources.

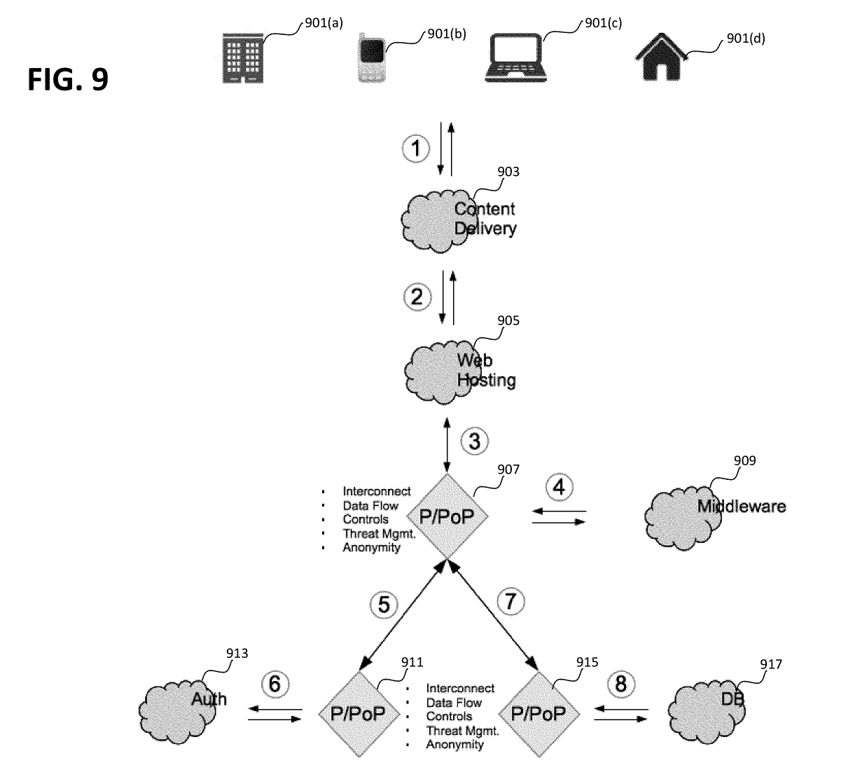

FIG. 9 illustrates another example of end-to-end data flow scenario for part of the system according to an embodiment of the present disclosure. As shown in FIG. 9, not all elements and providers of functions that make up the application are required to function within the boundaries of the present system. For example, as shown in the data flow transmission process 1, the users/user devices 901(a)-901(d) communicate with a provider of Content Delivery services 903. The provider of Content Delivery services 903 then communicates with the provider of Web Hosting services 905 without using P/PoPs via a public or private network, as shown in the data flow transmission process 2. The P/PoP, for example P/PoP 907, comes into play only when the Provider of Web Hosting services 905 needs to communicate to the Provider of Middleware services 909, as shown in the data flow transmission processes 3-4. From there-on the data flow transmission processes 4-8 will be similar with the data flow transmission processes 6-10 in FIG. 8 as described above.

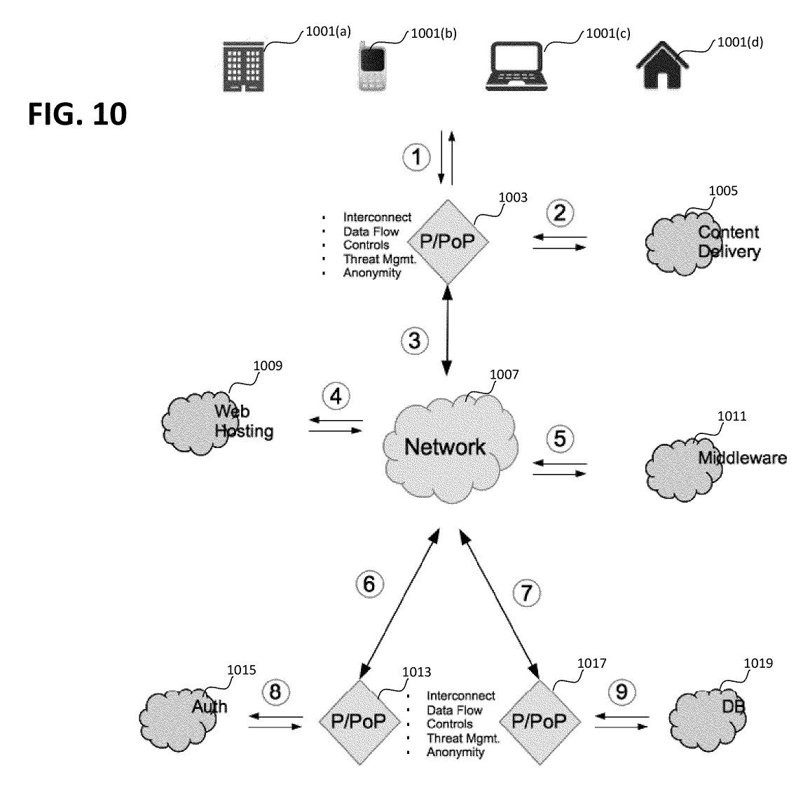

FIG. 10 illustrates another example of end-to-end data flow scenario for where some elements of the communications utilize other means of communications according to an embodiment of the present disclosure. As shown in FIG. 10, the system may be used to front-end any application where some element of the application, for example, providers of Web Hosting 1009 and providers of Middleware services 1011, are not running through the functions provided by the P/PoPs and utilize another public or private means for communications, while other elements of the application, such as providers of Authentication and Database services 1019, do utilize P/PoPs for the purposes of interconnect, data flow, controls, threat management and anonymity.

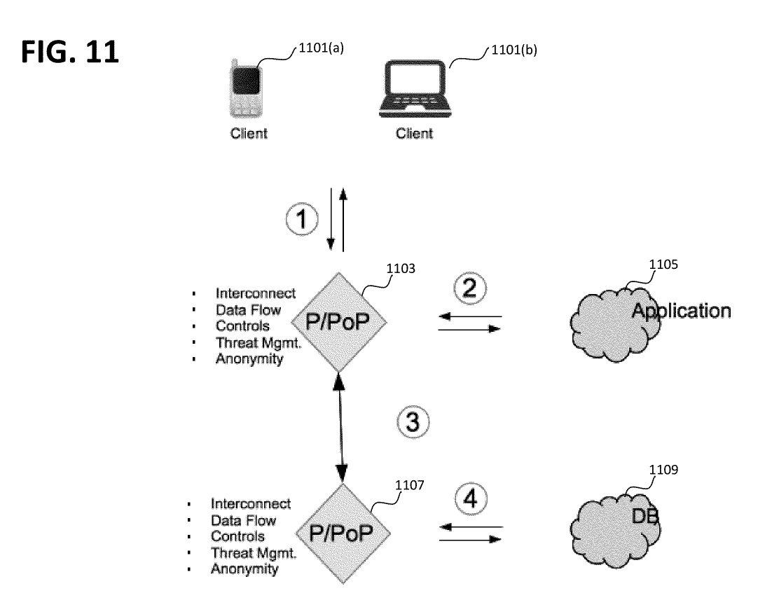

FIG. 11 illustrates another example of end-to-end data flow scenario for a client/server application model according to an embodiment of the present disclosure. As shown in FIG. 11, in the data flow transmission processes 1-2, users/user devices 1101(a)-1101(b) use client software for connecting to the provider of virtualized Server services 1105 through a P/PoP 1103 which may provide interconnect, data flow, controls, threat management and anonymity.

And then as shown in the data flow transmission processes 2-3-4, the communication between the Provider of virtualized Server services 1105 and the provider of virtualized Database services 1109 is through one or more P/PoPs, for example, P/PoPs 1103 and 1107, which may deliver interconnect, data flow, controls, threat management and anonymity. For example, after receiving the information from users/user devices 1101(a)-1101(b), the provider of virtualized Server services 1105 needs to get user information which is located in a database. The provider of virtualized Server services 1105 requests this information from the provider of virtualized Database services 1109 through one or more P/PoPs, for example, P/PoPs 1103 and 1107, which provides interconnect, data flow, controls, threat management and anonymity between the provider of virtualized Server services 1105 and the provider of virtualized Database services 1109.

As shown in the data flow transmission processes 4-3-2, the provider of virtualized Database services 1109 responds to the provider of virtualized Server services 1105 with the requested information through one or more P/PoPs, for example, P/PoPs 1107 and 1103, which provides interconnect, data flow, controls, threat management and anonymity between the of virtualized Database services 1109 and the virtualized Server services 1105.

Then as shown in the data flow transmission processes 2-1, the provider of virtualized Server services 1105 responds to the original request from the user. This communications flows through a P/PoP 1103 that provides interconnect, data flow, controls, threat management and anonymity between the two resources virtualized Server services 1105 and the user.

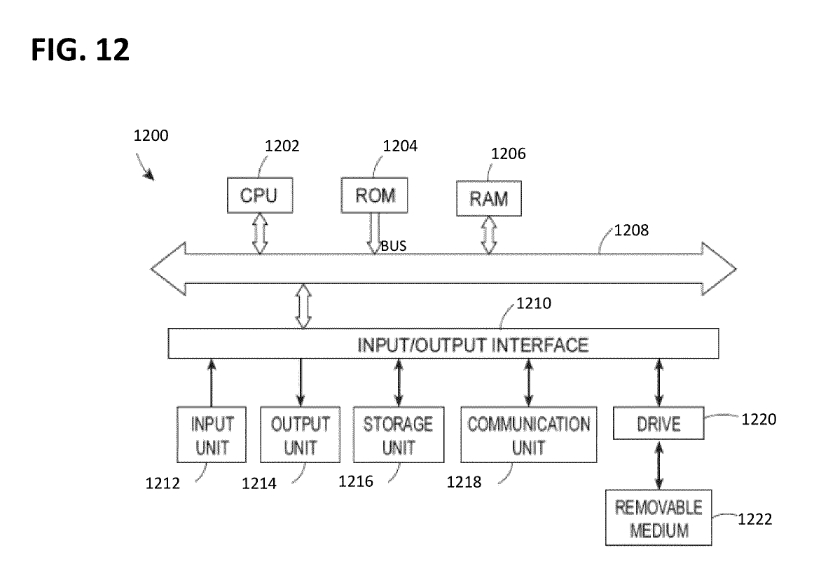

FIG. 12 illustrates an exemplary structure of a server, system, or a terminal according to an embodiment.

The exemplary server, system, or terminal 1200 includes a CPU 1202, a ROM 1204, a RANI 1206, a bus 1208, an input/output interface 1210, an input unit 1212, an output unit 1214, a storage unit 1216, a communication unit 1218, and a drive 1220. The CPU 1202, the ROM 1204, and the RANI 1206 are interconnected to one another via the bus 1208, and the input/output interface 1210 is also connected to the bus 1208. In addition to the bus 1208, the input unit 1212, the output unit 1214, the storage unit 1216, the communication unit 1218, and the drive 1220 are connected to the input/output interface 1210.

The CPU 1202, such as an Intel Core™ or Xeon™ series microprocessor or a Freescale™ PowerPC™ microprocessor, executes various kinds of processing in accordance with a program stored in the ROM 1204 or in accordance with a program loaded into the RAM 1206 from the storage unit 1216 via the input/output interface 1210 and the bus 1208. The ROM 1204 has stored therein a program to be executed by the CPU 1202. The RAM 1206 stores as appropriate a program to be executed by the CPU 1202, and data necessary for the CPU 1202 to execute various kinds of processing.

A program may include any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below

The input unit 1212 includes a keyboard, a mouse, a microphone, a touch screen, and the like. When the input unit 1212 is operated by the user, the input unit 1212 supplies an input signal based on the operation to the CPU 1202 via the input/output interface 1210 and the bus 1208. The output unit 1214 includes a display, such as an LCD, or a touch screen or a speaker, and the like. The storage unit 1216 includes a hard disk, a flash memory, and the like, and stores a program executed by the CPU 1202, data transmitted to the terminal 1200 via a network, and the like.

A removable medium 1222 formed of a magnetic disk, an optical disc, a magneto-optical disc, flash or EEPROM, SDSC (standard-capacity) card (SD card), or a semiconductor memory is loaded as appropriate into the drive 1220. the drive 1220 reads data recorded on the removable medium 1222 or records predetermined data on the removable medium 1222.

One skilled in the art will recognize that, although the data storage unit 1216, ROM 1204, RANI 1206 are depicted as different units, they can be parts of the same unit or units, and that the functions of one can be shared in whole or in part by the other, e.g., as RAM disks, virtual memory, etc. It will also be appreciated that any particular computer may have multiple components of a given type, e.g., CPU 1202, Input unit 1212, communications unit 1218, etc.

An operating system such as Microsoft Windows 7®, Windows XP® or Vista™, Linux®, Mac OS®, or Unix® may be used by the terminal. Other programs may be stored instead of or in addition to the operating system. It will be appreciated that a computer system may also be implemented on platforms and operating systems other than those mentioned. Any operating system or other program, or any part of either, may be written using one or more programming languages such as, e.g. Java®, C, C++, C#, Visual Basic®, VB.NET®, Perl, Ruby, Python, or other programming languages, possibly using object oriented design and/or coding techniques.

Data may be retrieved, stored or modified in accordance with the instructions. For instance, although the system and method is not limited by any particular data structure, the data may be stored in computer registers, in a relational database as a table having a plurality of different fields and records, XML documents, flat files, etc. The data may also be formatted in any computer-readable format such as, but not limited to, binary values, ASCII or Unicode. The textual data might also be compressed, encrypted, or both. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

It will be understood by those of ordinary skill in the art that the processor and memory may actually comprise multiple processors and memories that may or may not be stored within the same physical housing. For example, some of the instructions and data may be stored on removable memory such as a magneto-optical disk or SD card and others within a read-only computer chip. Some or all of the instructions and data may be stored in a location physically remote from, yet still accessible by, the processor. Similarly, the processor may actually comprise a collection of processors which may or may not operate in parallel. As will be recognized by those skilled in the relevant art, the terms “system,” “terminal,” and “server” are used herein to describe a computer's function in a particular context. A terminal may, for example, be a computer that one or more users work with directly, e.g., through a keyboard and monitor directly coupled to the computer system. Terminals may also include a smart phone device, a personal digital assistant (PDA), thin client, or any electronic device that is able to connect to the network and has some software and computing capabilities such that it can interact with the system. A computer system or terminal that requests a service through a network is often referred to as a client, and a computer system or terminal that provides a service is often referred to as a server. A server may provide contents, content sharing, social networking, storage, search, or data mining services to another computer system or terminal. However, any particular computing device may be indistinguishable in its hardware, configuration, operating system, and/or other software from a client, server, or both. The terms “client” and “server” may describe programs and running processes instead of or in addition to their application to computer systems described above. Generally, a (software) client may consume information and/or computational services provided by a (software) server or transmitted between a plurality of processing devices.

As used in this application, the terms “component” or “system” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Systems and methods described herein may by implemented by software, firmware, hardware, or any combinations of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

A network environment as described herein can comprise any combination of linked computers, or processing devices, adapted to transfer and process data. Non-limiting exemplary network environments are described in U.S. patent application Ser. No. 13/910,609 entitled SYSTEM AND METHOD FOR PROVIDING A SINGLE GLOBAL BORDERLESS VIRTUAL PERIMETER THROUGH DISTRIBUTED POINTS OF PRESENCE and filed on Jun. 5, 2013, U.S. patent application Ser. No. 13/828,296 entitled SYSTEM AND METHOD FOR CONTROLLING, OBFUSCATING AND ANONYMIZING DATA AND SERVICES WHEN USING PROVIDER SERVICES and U.S. patent application Ser. No. 13/827,940 entitled NETWORK SYSTEM AND METHOD FOR IMPROVING ROUTING CAPABILITY the entirety of each of which are incorporated by reference hereby. The network may be private Internet Protocol (IP) networks, as well as public computer networks, such as the Internet that can utilize World Wide Web (www) browsing functionality. An example of a wired network is a network that uses communication buses and MODEMS, or DSL lines, or a local area network (LAN) or a wide area network (WAN) to transmit and receive data between terminals. An example of a wireless network is a wireless LAN. A cellular network such as Global System for Mobile Communication (GSM) and Enhanced Data rates for GSM Evolution (EDGE) or LTE Advanced is another example of a wireless network. Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers. Yet, other examples of a wireless network may include a 3G communication network or a 4G communication network. Yet another example of a wireless network is Near field communication, or NFC, which are a set of short-range wireless technologies. NFC, which typically acts a distance of 4 cm or less and operates at 13.56 MHz and at rates ranging from 106 kbit/s to 848 kbit/s. NFC involves: an initiator that generates an RF field, which in turn powers a passive target. The NFC target can take a very simple form factors such as tags, stickers, key fobs, or cards that do not require batteries, but can also be used in conjunction with smart cards or phones incorporating NFC functionality.

According to an embodiment, each of the servers and terminals may be, for example, a server computer operatively connected to network, via bi-directional communication channel, or interconnector, respectively, which may be for example a serial bus such as IEEE 1394, or other wire or wireless transmission medium. The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between the remote modules or devices.

The servers and terminals are adapted to transmit data to, and receive data from, each other via the network. The servers and terminals typically utilize a network service provider, such as an Internet Service Provider (ISP) or Application Service Provider (ASP) (ISP and ASP are not shown) to access resources of the network.

It will be appreciated by those ordinarily skilled in the art that the foregoing brief description and the following detailed description are exemplary (i.e., illustrative) and explanatory of the subject matter as set forth in the present disclosure, but are not intended to be restrictive thereof or limiting of the advantages that can be achieved by the present disclosure in various implementations. Additionally, it is understood that the foregoing summary and ensuing detailed description are representative of some embodiments as set forth in the present disclosure, and are neither representative nor inclusive of all subject matter and embodiments within the scope as set forth in the present disclosure. Thus, the accompanying drawings, referred to herein and constituting a part hereof, illustrate embodiments of this disclosure, and, together with the detailed description, serve to explain principles of embodiments as set forth in the present disclosure.

1. A network system comprising:
one or more Perimeter Points of Presence (P/PoP) configured to interconnect and enforce policy between a plurality of entities, each entity providing at least one function for implementing an application, comprising:
a plurality of functions layers for processing data, wherein at least one of the function layers can be configured with a customized virtual perimeter for the entities,
wherein the one or more Perimeter Points of Presence (P/PoP) are configured to receive data via a connection to the Perimeter Points of Presence (P/PoP);
process the data using at least one of the function layers configured as a data processing policy for the entity; and
transmit the processed data as policy compliant data from the one or more Perimeter Points of Presence (P/PoP) to a destination connected to the Perimeter Points of Presence (P/PoP),
wherein the policy compliant data includes application function data for implementing an application.

2. The system of claim 1, wherein the one or more Perimeter Points of Presence (P/PoP) further comprising:
a Sequencer
layer that provides traffic direction.

3. The system of claim 1, wherein the plurality of interconnected entities provide are configured to execute a function for an application, wherein the implementation of the application is dependent upon execution of the functions by each of the plurality of entities.

4. The system of claim 1, wherein entity is configured to perform at least one of a plurality of actions with respect to the received data.

5. The system of claim 1, wherein the one or more Perimeter Points of Presence (P/PoP) are configured to process the received data in parallel, serially, or both.

6. The system of claim 1, wherein the received data is communicated from an unknown source, the unknown source being an entity beyond the organizational control of an entity associated with the customized virtual perimeter.

7. The system of claim 1, wherein the one or more P/PoP is configured to leverage a physical connection comprising a dedicated physical connection to connect to the one or more P/PoPs to facilitate communications through the one or more P/PoP to other destinations.

8. The system of claim 1, wherein the one or more P/PoP is configured to leverage a virtual connection comprising a long-term or temporary virtual connection over private networks, public networks, or both to connect to the one or more P/PoP to facilitate communications through the one or more P/PoP to other destinations.

9. The system of claim 1, wherein the one or more P/PoP is configured to leverage a controlled connection when communication is limited to flow through one or more P/PoP via implemented controls.

10. The system of claim 1, wherein the P/PoP is configured to simultaneously leverage physical, virtual and controlled connections, the configuration comprising at least one of:
the physical, virtual and controlled connections as components of a single connection, and
to connect to the one or more P/PoP to facilitate communications through the one or more P/PoP to other destinations.

11. The system of claim 1, wherein the entities are interconnected via one or more connection selected from a plurality of connections comprising a group of private physical connection, public connection, hybrid connection, private virtual connection over a public medium or network, private virtual connection over a hybrid medium or network, and private virtual connection over a private medium or network.

12. The system of claim 1, wherein the plurality of entities comprising: a computer platform, a data center, a plurality of providers of virtualized service, a cloud instance, a mobile device, a remote user, and an access end-point.

13. The system of claim 12, wherein the plurality of providers of virtualized service includes a provider of virtualized authentication services, a provider of virtualized database services, a provider of virtualized web services, a provider of virtualized middleware services, a provider of virtualized content delivery services, and a provider of virtualized web hosting services.

14. The system of claim 1, wherein the plurality of functions layers includes one or more function layers selected from a plurality of function layers comprising the group of: application delivery and resiliency layer, visibility and assessment layer, security and privacy layer, acceleration layer, and anonymity layer.

15. The system of claim 1, wherein one or more of the functions for each entity are configured to be administered by one or more respective administrative systems for each entity.

16. The system of claim 15 further comprising at least one or more P/PoPs for a first entity being operatively connected to at least one administrative system for the first entity, wherein the administrative system for the first entity is configured to support at least one respective function.

17. The system of claim 16 wherein the one or more administrative systems comprises one or more administrative systems selected from the group of: a provisioning system, a management system, a metering system, and a logging system.

18. The system of claim 17, wherein the provisioning system supports a marketplace function,
the management system supports a policy function, the logging system supports a reporting function, and the metering system supports a billing function.

19. The system of claim 16 further comprising one or more P/PoPs for at least one second entity are also connected to at least one administrative system for the at least one second entity,
wherein the administrative system for the at least one second entity is configured to support the at least one respective function, and
wherein the at least one administrative system for the second entity is distinct from the one administrative system for the first entity.

20. A method implemented by at least one computer comprising a processor, memory, and a computer readable medium storing thereon computer code thereon, wherein the computer is configured to perform at least:
accepting network connections at one or more Perimeter Points of Presence (P/PoP) configured to interconnect and enforce policy between a plurality of entities including at least one entity associated with a customized virtual perimeter, each of the plurality of entities providing at least one function;
receiving a data flow from a data source at the one or more Perimeter Points of Presence (P/PoP);
processing the data using at least one of function layers configured as a data processing policy for the entity; and
transmitting the processed data flow as policy compliant data flow from the one or more Perimeter Points of Presence (P/PoP) to an end point,
wherein the policy compliant data includes application function data for implementing an application.
